(19) United States
(12) Patent Application Publication
(10) Pub. No.: US 2026/0329277 A1
(43) Pub. Date: Oct. 22, 2026

(54) OWNERSHIP-GATED MISSION AUTHORIZATION AND CUSTODY CONTROL FOR MOBILE PHYSICAL ARTIFICIAL INTELLIGENCE (AI) AGENTS

(71) Applicant: Dorian Cartwright, San Jose, CA (US)

(72) Inventor: Dorian Cartwright, San Jose, CA (US)

(21) Appl. No.: 19/696,651

(22) Filed: Jun. 3, 2026

(51) Int. Cl. G05D 1/229; B25J 9/16; G06N 3/006

(52) U.S. Cl. CPC G05D 1/229; B25J 9/1679; G06N 3/006

(57) ABSTRACT

A mobile physical AI agent includes an ownership authorization module, a mission validation module, a custody state machine, and an actuation control interface. The ownership authorization module associates a task instruction with a responsible party account. The mission validation module determines whether the task instruction corresponds to a public space mission and generates a mission authorization package defining permitted mission scope, route conditions, jurisdictional constraints, financial responsibility conditions, supervision requirements, and fallback custody conditions. The actuation control interface permits, restricts, or prevents locomotion or manipulation based on whether a current state of the agent satisfies the mission authorization package. In some embodiments, the agent detects a ghost robot or abandonment condition based on owner unreachability, mission expiration, invalid insurance or bond status, or public space stagnation, and transitions to a reduced-risk fallback custody mode.

### FIELD OF THE INVENTION

The present disclosure relates generally to computers and artificial intelligence, and more specifically, to determining whether a mobile physical AI agent is authorized for a public space mission.

### BACKGROUND

Mobile robots and humanoid robots are increasingly capable of operating outside controlled industrial environments. A mobile physical AI agent may navigate sidewalks, buildings, parking lots, retail spaces, warehouses, campuses, airports, roadsides, residential areas, or other shared environments. Such agents may be commanded by individuals, fleet operators, businesses, remote operators, cloud services, or artificial intelligence planners. In many systems, if an authenticated user issues a command and the robot determines that a path is physically navigable, the robot may attempt to execute the command subject to local obstacle avoidance, route planning, collision avoidance, or safety monitoring.

This model is incomplete for public and semi-public operation. A command may be issued by a person who has login credentials but who is not a proper custodian for the robot, lacks authority for the requested mission, lacks required insurance or financial responsibility, has not provided a retrieval plan, has no valid supervision endpoint, or seeks to send the robot into jurisdictions or premises where operation is prohibited or restricted. For example, an owner may instruct a humanoid robot to walk from San Francisco to New York. The robot may be physically capable of initiating locomotion, but such a mission may involve extended unattended operation, numerous municipal and state jurisdictions, changing sidewalk and roadway rules, charging needs, service needs, insurance requirements, risk of abandonment, and potential disputes about responsibility if the robot obstructs a sidewalk, damages property, injures a person, or becomes stranded.

Existing robot authentication systems generally verify that a user is allowed to access a device or account. Existing fleet management systems may assign missions based on battery level, availability, route efficiency, warehouse state, or payload status. Existing delivery robot systems may maintain chain of custody for items carried by a robot. Existing autonomous vehicle and drone regimes may require operator registration, proof of insurance, or device identification. These approaches do not provide a mission-level ownership gate that dynamically binds a robot identity, responsible party credential, mission scope, route, jurisdictional constraints, insurance or bond status, fallback custody plan, and actuation permission for a particular public space mission.

A further problem arises when a robot loses its responsible party during operation. A mobile robot may become a ghost robot, orphan robot, abandoned robot, or unclaimed robot. For example, an owner may become unreachable, fail to pay for required services, fail to renew insurance, revoke or abandon a mission, lose communication, or fail to retrieve the robot. The robot may remain in public space, continue to consume power, block a path, create confusion, or attempt to continue an invalid mission. Conventional lost connection behavior such as stopping, returning to base, or waiting for a network connection does not address the legal, financial, custodial, and municipal dimensions of an autonomous physical agent that no longer has an active responsible party.

There is therefore a need for a robust robot ownership and custody gating architecture that determines whether a mission has a valid responsible party and associated authorization package before and during public space operation. There is also a need for abandonment detection, fallback custody, custody transfer, insurance or bond-gated actuation, jurisdiction-aware mission segmentation, and liability attribution for physical actions of mobile physical AI agents.

### SUMMARY

The present disclosure addresses these shortcomings with systems, methods, and computer program products for robot ownership and custody gating architecture that determines whether a mission has a valid responsible party and associated authorization package before and during public space operation.

In one embodiment, a mobile physical AI agent includes a locomotion system, one or more processors, an ownership authorization module, a mission validation module, a custody state machine, and an actuation control interface. The ownership authorization module associates a received task instruction with a responsible party account, owner account, custodian account, operator account, fleet account, or other accountable entity. The mission validation module determines whether the received task instruction corresponds to a public space mission, semi-public space mission, long-range mission, cross-jurisdiction mission, high-risk mission, unattended mission, or other mission requiring ownership-gated authorization. The mission validation module generates or validates a mission authorization package that defines permitted mission scope, route or geofence conditions, mission duration conditions, jurisdictional conditions, supervision conditions, financial responsibility conditions, and fallback custody conditions. The actuation control interface permits, restricts, derates, or prevents locomotion or manipulation based on whether a current state of the mobile physical AI agent satisfies the mission authorization package.

In some embodiments, a received task instruction is a natural language, symbolic, API, scheduled, or planner-generated instruction. For example, an owner may instruct a robot to walk from a first city to a second city, pick up an object, deliver an item, accompany a person, wait at a location, enter a premises, board a vehicle, or obtain energy or service. The ownership gate may classify the task as requiring public space authorization based on one or more of distance, duration, expected unattended time, number of jurisdictions traversed, route type, pedestrian density, object manipulation requirement, payload, operating time, insurance class, owner reachability, service account state, or fallback retrieval feasibility.

In some embodiments, the mission authorization package includes a robot identity, a responsible party identity, a custodian identity, an owner signature, a command receipt, a mission identifier, a permitted route, a geofence, a jurisdiction list, a public/private/semi-public environment classification, a time window, a maximum autonomous duration, a supervision heartbeat requirement, an insurance token, a bond token, a service account token, a retrieval plan, a fallback custodian, an emergency contact, a municipal endpoint, an impound endpoint, a permitted manipulation envelope, a permitted locomotion envelope, and one or more revocation conditions.

In some embodiments, a cryptographic mission authorization token is generated from the mission authorization package. A motor controller, locomotion controller, manipulation controller, actuator firewall, or robot operating system layer may accept motion or manipulation commands only when accompanied by a currently valid mission authorization token. In other embodiments, the mission authorization token may cause the robot to adopt an actuation envelope, speed cap, route constraint, manipulation limit, human-interaction limit, or fallback behavior.

In some embodiments, a custody state machine maintains a custody state of the mobile physical AI agent. The custody state may include one or more of uninitialized, owned idle, private operation, public mission candidate, mission authorized, active mission, paused mission, owner unreachable, insurance expired, mission expired, custody transfer pending, temporary stewardship, fallback custody, ghost robot, abandoned robot, municipal impound, service custody, emergency custody, and recovered. The custody state may be updated based on owner heartbeat, custodian heartbeat, mission progress, location, jurisdictional status, insurance status, bond status, service account status, battery state, physical condition, municipal command, or remote operator input.

In some embodiments, the system detects a ghost robot or abandonment condition. The condition may be detected in response to loss of owner communication beyond a threshold, loss of custodian communication, failure to acknowledge periodic pings, expiration of a mission time window, insurance or bond revocation, service account lapse, prolonged stagnation in a public space, inability to reach a destination, repeated path blockage, critical battery state without retrieval, physical distress, tip-over state, vandalism condition, municipal impound request, or failure of a custodian to accept transfer. In response, the robot may restrict locomotion, disable object manipulation, reduce speed, avoid road crossings, move out of pedestrian flow, broadcast an abandoned or ghost status, display an emergency contact, navigate to a fallback custody location, request retrieval, enter municipal impound mode, or preserve evidence logs.

In some embodiments, a cross-jurisdiction mission segmentation module partitions a route into jurisdiction-specific segments. The system may retrieve or apply segment-specific rules, including permitted operating hours, sidewalk restrictions, roadway restrictions, speed limits, remote-supervision requirements, insurance minimums, payload restrictions, municipal permit requirements, premises rules, and fallback custodian availability. The robot may deny a mission, require additional authorization, require a custody transfer, require alternative transportation, or modify an actuation envelope when one or more segments lack authorization.

In some embodiments, an insurance or bond-gating module verifies a machine-readable financial responsibility token. The token may be tied to a robot hardware identifier, responsible party account, mission identifier, route segment, risk score, time window, payload, operating environment, or jurisdiction. If the token is invalid, expired, revoked, insufficient, excluded for a route segment, below a risk threshold, or otherwise noncompliant, the robot may prevent mission initiation, reduce speed, disable manipulation, avoid public space, return to a private location, navigate to fallback custody, or enter a ghost or impound state.

In some embodiments, a liability attribution ledger records custody, control, authorization, and telemetry states associated with robot actions. The ledger may be local, cloud-hosted, distributed, centralized, append-only, tamper-resistant, cryptographically linked, or periodically synchronized. Entries may include a robot identifier, mission identifier, timestamp, location, environmental classification, jurisdiction segment, custodian identifier, owner identifier, controller identity, planner identity, remote operator identity, policy identifier, insurance identifier, bond identifier, command receipt, mission authorization package hash, sensor health state, actuation envelope, physical action, safety override, municipal override, custody transfer event, ghost-state transition, or telemetry hash. The ledger may be used after an incident to determine which party, controller, authorization source, or custody state was associated with the robot at a time of interest.

In some embodiments, a custody transfer protocol allows responsibility for a robot to be temporarily or permanently transferred. An outgoing custodian may sign a release, and an incoming custodian may sign an acceptance. The robot or a custody server may verify that the incoming custodian has authority, permits, financial responsibility, route coverage, service capability, physical possession capability, or infrastructure access. The robot may update trusted controller credentials, adjust allowed mission types, change actuation envelopes, enter service custody, accept municipal custody, or revert to fallback custody if the temporary stewardship expires.

The disclosed systems may be implemented on a humanoid robot, wheeled delivery robot, quadruped robot, mobile manipulator, autonomous errand robot, sidewalk robot, service robot, industrial mobile robot, telepresence robot, robot passenger in an autonomous vehicle, robot using elevators or smart buildings, or other mobile physical AI agent. The ownership gate may operate on-board the robot, in a cloud service, in a fleet-management system, in a municipal system, in a robot operating system, in an actuator firewall, in a secure enclave, or in a distributed architecture.

### BRIEF DESCRIPTION OF FIGURES

FIG. 1 is a schematic diagram illustrating a mobile physical AI agent with an ownership gate positioned between a mission planner and a physical execution layer, according to an embodiment.

FIG. 2 is a block diagram illustrating generation of a mission authorization package and a mission authorization token, according to an embodiment.

FIG. 3 is a state machine diagram illustrating custody states of a mobile physical AI agent, according to an embodiment.

FIG. 4 is a route segmentation diagram illustrating cross-jurisdiction mission segmentation for a mobile physical AI agent, according to an embodiment.

FIG. 5 is a block diagram illustrating insurance or bond-gated public space operation of a mobile physical AI agent, according to an embodiment.

FIG. 6 is a block diagram illustrating a liability attribution ledger and custody transfer protocol, according to an embodiment.

FIG. 7 is a flow chart illustrating a method for ownership-gated mission authorization, according to an embodiment.

FIG. 8 is a flow chart illustrating a method for ghost robot detection and fallback custody, according to an embodiment.

FIG. 9 is a block diagram illustrating a computing environment for implementing components of the system, according to an embodiment.

### DETAILED DESCRIPTION

The following description provides systems, methods, and computer program products for ownership-gated mission authorization and custody control for mobile physical artificial intelligence agents. The described embodiments are illustrative and not limiting. Features described with respect to one embodiment may be combined with features of other embodiments unless context indicates otherwise. Like reference numerals may refer to like or functionally related elements throughout the drawings.

### I. Systems for Ownership-Gated Mission Control

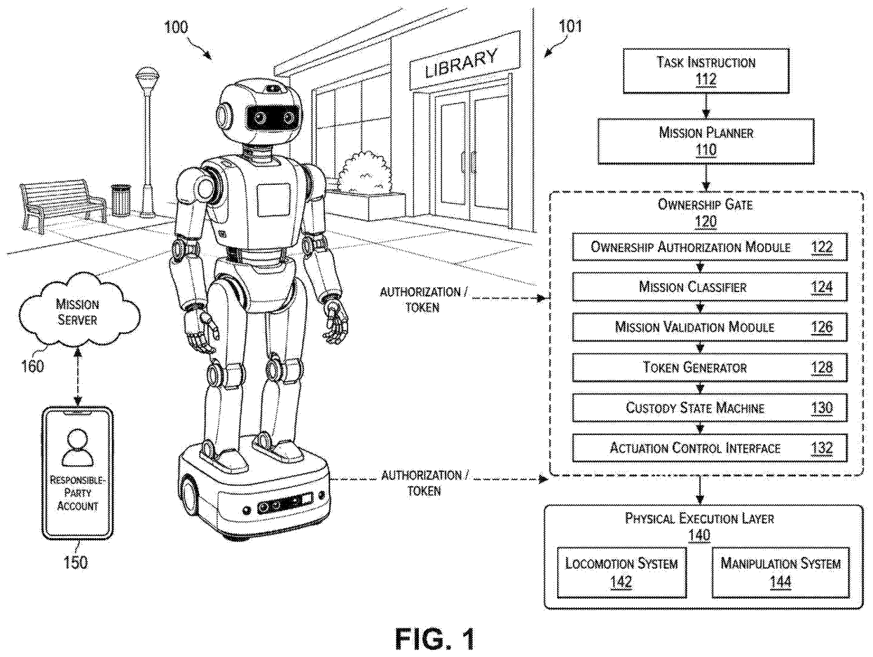

FIG. 1 illustrates a mobile physical AI agent 100 operating in a public or semi-public environment 101. The mobile physical AI agent 100 may be a humanoid robot, wheeled robot, quadruped robot, mobile manipulator, delivery robot, sidewalk robot, service robot, industrial mobile robot, telepresence robot, autonomous errand robot, robot passenger in an autonomous vehicle, robot configured to use building infrastructure, or other physically embodied artificial intelligence system.

In the example of FIG. 1, a task instruction 112 is received by or provided to a mission planner 110. The task instruction 112 may be a natural-language instruction, symbolic instruction, application programming interface command, scheduled task, fleet-management instruction, remote-operator instruction, planner-generated instruction, or other mission request. The mission planner 110 may include or interoperate with a high-level planner, vision-language-action model, behavior planner, cloud agent, local autonomy stack, route planner, fleet controller, or remote user interface that generates a proposed mission or action sequence.

An ownership gate 120 is interposed between the mission planner 110 and a physical execution layer 140. The ownership gate 120 determines whether the proposed mission or action sequence is within a valid ownership, custody, authorization, jurisdictional, financial responsibility, and fallback custody envelope before locomotion or manipulation is permitted. In this manner, the mobile physical AI agent 100 treats a mission as a proposal subject to responsible party and custody validation rather than as an immediately executable physical instruction.

The ownership gate 120 may include an ownership authorization module 122, a mission classifier 124, a mission validation module 126, a token generator 128, a custody state machine 130, and an actuation control interface 132. The ownership gate 120 may be implemented locally on the mobile physical AI agent 100, remotely in a mission server 160, in a fleet-management system, in a municipal system, in a robot operating system, in an actuator firewall, in a secure enclave, in a cloud custody service, or across a distributed architecture.

The ownership authorization module 122 associates the task instruction 112 with a responsible party account 150. The responsible party account 150 may correspond to an owner, lessee, fleet operator, parent account, guardian account, business, employer, service provider, insurer-designated custodian, municipal agency, emergency responder, temporary steward, premises operator, robot valet, charging-service provider, maintenance provider, or other entity that accepts responsibility for at least a portion of robot operation. The ownership authorization module 122 may verify a password, biometric credential, device credential, private key signature, multi-factor authentication, delegated authorization token, custodian certificate, business credential, municipal credential, or other credential.

Authentication by the responsible party account 150 does not alone authorize a mission. The mission classifier 124 determines whether the task instruction 112 requires ownership-gated authorization. In one embodiment, the mission classifier 124 receives a natural-language instruction such as “walk from San Francisco to New York,” “go to the store and pick up my package,” “wait outside this house,” “follow that person,” “deliver this item,” “go charge yourself,” or “take an autonomous vehicle to the airport.” The mission classifier 124 may parse the instruction, generate a candidate route or task graph, estimate duration, identify public or semi-public exposure, identify expected human interactions, identify object interactions, identify infrastructure interactions, and determine whether the mission crosses a threshold requiring a mission authorization package.

The threshold may be based on expected travel distance, expected time outside a private boundary, number of public space segments, number of jurisdictional boundaries, expected road crossings, expected elevator or vehicle use, expected object pickup or delivery, expected payload risk, expected interaction with a restricted item, expected use of charging or cloud resources, expected operation without owner supervision, expected operation during restricted hours, expected presence in a high-density pedestrian area, or combinations thereof. The mission classifier 124 may output a mission class such as private local task, private mission, semi-public mission, public mission, long-range public mission, cross-jurisdiction mission, high-risk mission, restricted-object mission, infrastructure-dependent mission, or mission requiring temporary custody transfer.

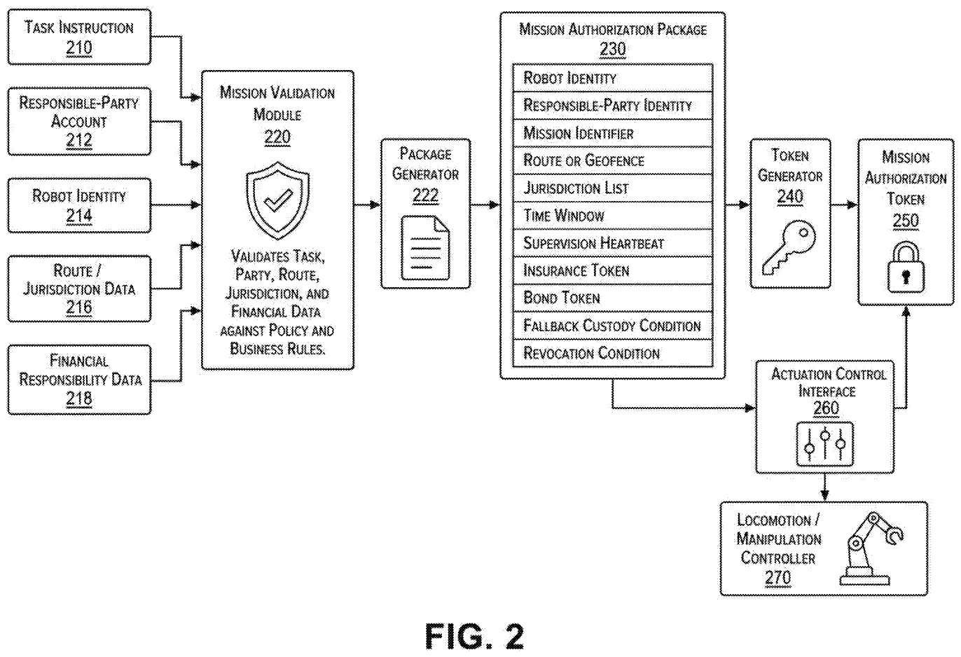

The mission validation module 126 generates or verifies a mission authorization package. As illustrated in FIG. 2, the mission validation module 220 may receive a task instruction 210, responsible party account information 212, robot identity 214, route or jurisdiction data 216, and financial responsibility data 218. The mission validation module 220 validates the task, party, route, jurisdiction, and financial data against policies, business rules, insurance conditions, municipal constraints, custody conditions, and fallback requirements.

A package generator 222 generates a mission authorization package 230. The mission authorization package 230 may include, without limitation, a robot identity, responsible party identity, mission identifier, route or geofence, jurisdiction list, time window, supervision heartbeat requirement, insurance token, bond token, fallback custody condition, and revocation condition. The mission authorization package 230 may additionally include an owner identity, custodian identity, responsible party credential, mission description, source command, command receipt, owner signature, route segment list, destination, permitted location classes, maximum distance, maximum duration, allowed operating hours, public space permission, semi-public permission, premises permission, municipal permit state, municipal authorization token, coverage limit, exclusions, service account state, payment token, retrieval plan, fallback custodian, fallback location, emergency contact, municipal endpoint, impound endpoint, remote-operator endpoint, network requirement, energy reserve requirement, maintenance state, permitted manipulation classes, permitted locomotion classes, speed limits, force limits, payload declarations, privacy constraints, prohibited actions, and ledger-recording requirements.

A token generator 240 may generate a mission authorization token 250 from the mission authorization package 230. The mission authorization token 250 may be cryptographically signed by an owner, custodian, insurer, fleet operator, municipal authority, infrastructure provider, fallback custodian, or mission authorization service. The mission authorization token 250 may be bound to a robot hardware identifier, secure element, public key, device certificate, mission identifier, time interval, route segment, jurisdiction, insurance policy, custody state, or combinations thereof. The mission authorization token 250 may be short-lived and may be refreshed before or during mission execution.

The mission authorization token 250 may define a permitted actuation envelope rather than merely a binary permission. For example, the mission authorization token 250 may permit walking on sidewalks at a maximum speed, prohibit manipulation of unattended objects, allow low-speed travel to a charging station, require a remote supervisor heartbeat, permit only fallback custody navigation, prohibit road crossings, prohibit entry into a jurisdiction-specific segment, or require a custody transfer before a next mission leg.

The actuation control interface 132 of FIG. 1 and the actuation control interface 260 of FIG. 2 enforce the ownership gate. The actuation control interface 260 may provide authorization information to a locomotion or manipulation controller 270. The actuation control interface may operate at a mission planner, motion planner, robot operating system, middleware layer, actuator firewall, motor driver, power distribution unit, locomotion controller, manipulation controller, secure enclave, hardware security module, or other enforcement point. The interface may deny mission initiation, prevent locomotion, prevent manipulation, derate operation, cap speed, cap force, restrict route, prevent crossing a jurisdictional boundary, disable high-power actuation, require human confirmation, require custody transfer, or transition the robot to fallback custody mode.

In some embodiments, the actuation control interface 132 requires that each locomotion command, manipulation command, motion segment, actuator release token, or public space actuation envelope reference a currently valid mission authorization token. The physical execution layer 140 may include a locomotion system 142 and a manipulation system 144. The locomotion system 142 may include wheels, tracks, legs, feet, propulsors, or other mobility structures. The manipulation system 144 may include arms, hands, grippers, doors, latches, cargo compartments, charging connectors, tool interfaces, or other structures capable of interacting with objects or infrastructure.

The ownership gate 120 may operate with, but is distinct from, a physical action validation gate. A physical action validation gate may determine whether a proposed physical action is safe or predicted to produce an acceptable physical outcome. The ownership gate 120 determines whether there is an accountable responsible party and mission authority for the broader mission. A robot may require both gates to be satisfied. For example, an owner-authorized mission may still be denied if a physical actuation validator predicts collision or excessive force. Conversely, a physically safe movement may be denied if the robot lacks valid custody, insurance, jurisdictional permission, supervision, or fallback custody.

### A. Custody State Machine, Ghost Robot Detection, and Fallback Custody

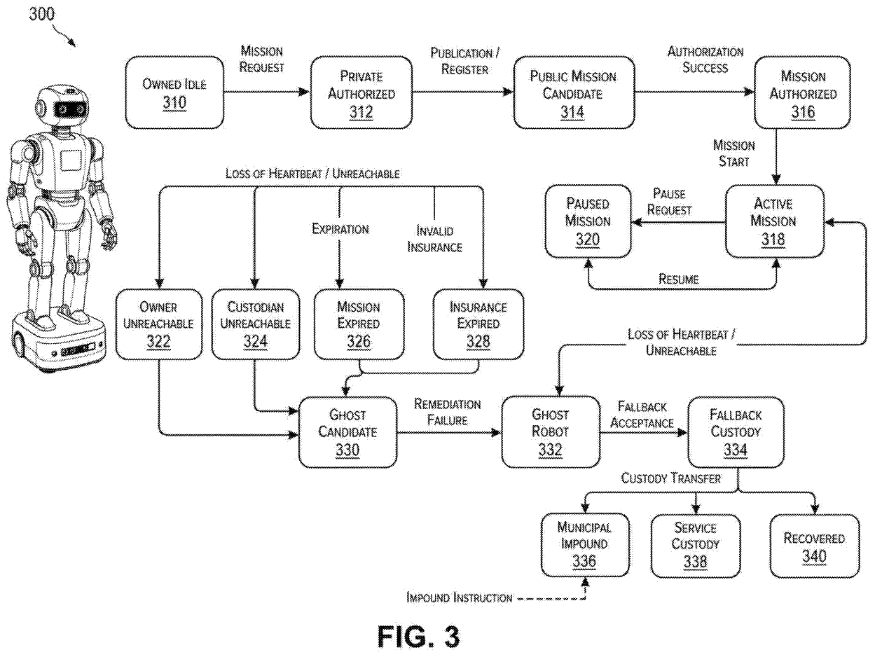

FIG. 3 illustrates a custody state machine 300 for maintaining a custody state of the mobile physical AI agent. The custody state represents who or what has responsibility for the robot and what physical operations are authorized in view of that responsibility. In one embodiment, the custody state machine 300 includes an owned idle state 310, private authorized state 312, public mission candidate state 314, mission authorized state 316, active mission state 318, paused mission state 320, owner-unreachable state 322, custodian-unreachable state 324, mission-expired state 326, insurance-expired state 328, ghost candidate state 330, ghost robot state 332, fallback custody state 334, municipal impound state 336, service custody state 338, and recovered state 340. Other state labels may be used.

A robot may transition from the owned idle state 310 to the private authorized state 312 in response to a mission request. The robot may transition from the private authorized state 312 to the public mission candidate state 314 in response to registration, publication, or detection that a mission will enter a public, semi-public, or cross-jurisdiction environment. The robot may transition from the public mission candidate state 314 to the mission authorized state 316 when authorization succeeds. The robot may transition from the mission authorized state 316 to the active mission state 318 when the mission begins.

The active mission state 318 may persist while required conditions remain satisfied. Conditions may include a valid owner or custodian credential, current mission authorization token, valid insurance or bond token, supervision heartbeat, route compliance, jurisdiction compliance, mission-duration compliance, energy reserve, service account validity, sensor health, and absence of municipal override. The robot may transition from the active mission state 318 to the paused mission state 320 in response to a pause request, temporary route blockage, temporary loss of a sensor signal, weather event, crowding condition, network congestion, temporary loss of GPS, energy constraint, or request for updated authorization. The robot may resume from the paused mission state 320 to the active mission state 318 when required conditions are restored.

The custody state machine 300 may transition to the owner-unreachable state 322, custodian-unreachable state 324, mission-expired state 326, or insurance-expired state 328 in response to loss of heartbeat, failure to acknowledge periodic pings, expiration of a mission time window, invalidation of a mission authorization package, invalidation of an insurance or bond token, service account lapse, municipal notification, or other condition. A robot in private space may tolerate longer owner silence than a robot operating on a sidewalk, in a municipal zone, or in another public or semi-public environment.

The ghost candidate state 330 may be entered when one or more remediation conditions are attempted or pending. During the ghost candidate state 330, the mobile physical AI agent may attempt to contact an owner, custodian, alternate responsible party, insurer-designated retrieval service, fleet operator, emergency contact, service depot, fallback custodian, or municipal endpoint. If remediation fails, the custody state machine 300 may transition to the ghost robot state 332. In some embodiments, the robot may enter the ghost robot state 332 immediately in response to explicit abandonment by an owner, municipal impound instruction, insurance cancellation for public operation, physical distress, tip-over state, vandalism condition, or unsafe condition requiring immediate custody intervention.

In the ghost robot state 332, the mobile physical AI agent may transition to reduced-risk operation. Reduced-risk operation may include disabling manipulation, disabling payload release, disabling high-speed locomotion, disabling road crossing, disabling stair traversal, disabling door manipulation, disabling following behavior, disabling interaction with children, reducing speaker volume, turning on visual status indicators, displaying ownership or emergency contact status, broadcasting an abandoned or ghost status, displaying a QR code or machine-readable custody credential, reducing power consumption, preserving evidence logs, or navigating only toward a safe harbor.

The fallback custody state 334 may be entered after fallback acceptance. A fallback custody response may be selected from the mission authorization package 230, a regional fallback registry, an insurer or bond provider, a municipal registry, a fleet-management service, a charging network, a service depot, a robot shelter, a robot valet, or a local policy cache. Selection may be based on distance, route safety, remaining energy, robot class, operating hours, capacity, contractual relationship, jurisdiction, security level, and whether the fallback custodian can physically accommodate the robot. The robot may request acceptance from a fallback custodian before navigating to a fallback location and may receive a limited fallback custody token authorizing restricted navigation to that location.

The custody state machine 300 may transition from fallback custody 334 to municipal impound 336, service custody 338, or recovered 340 through a custody transfer. A municipal authority may transmit an impound instruction or impound credential, after which the robot may verify the credential and transition to the municipal impound state 336. In municipal impound state 336, consumer owner commands may be locked out, while limited commands from authorized municipal personnel may be accepted. The robot may navigate to an impound location, self-immobilize for pickup, unlock a towing interface, disable manipulation, preserve logs, or provide a custody-transfer receipt.

### B. Cross-Jurisdiction Mission Segmentation and Insurance/Bond Gating

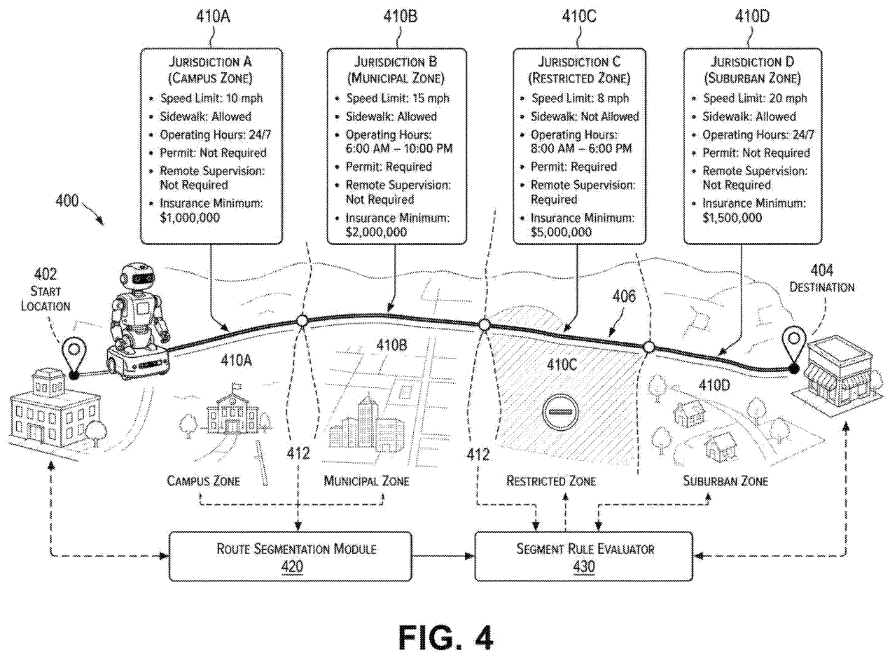

FIG. 4 illustrates cross-jurisdiction mission segmentation for a mobile physical AI agent 400. A proposed mission may include travel from a start location 402 to a destination 404 along a route 406. A route segmentation module 420 partitions the route 406 into jurisdiction-specific or policy-domain-specific segments 410A, 410B, 410C, and 410D. Segment boundaries 412 may correspond to city boundaries, county boundaries, state boundaries, private-property boundaries, special event zones, campuses, airports, hospitals, retail premises, restricted areas, sidewalks, bike lanes, roadways, tunnels, bridges, transit systems, parks, or municipal rule zones.

In the example of FIG. 4, segment 410A corresponds to Jurisdiction A, such as a campus zone, with a first set of operating constraints. Segment 410B corresponds to Jurisdiction B, such as a municipal zone, with a second set of operating constraints. Segment 410C corresponds to Jurisdiction C, such as a restricted zone, with a third set of operating constraints. Segment 410D corresponds to Jurisdiction D, such as a suburban zone, with a fourth set of operating constraints. These constraints may include speed limit, sidewalk permission, roadway permission, operating hours, permit requirement, remote-supervision requirement, insurance minimum, bond amount, lighting requirement, audible alert requirement, human-yield rule, payload restriction, weather restriction, parking rule, local impound endpoint, and other rule conditions.

The route segmentation module 420 may use maps, geofences, jurisdictional databases, municipal APIs, stored policies, third-party rule services, machine-readable permit records, sensor-derived environmental classifications, infrastructure beacons, or combinations thereof. A segment rule evaluator 430 determines whether the mission authorization package 230 satisfies constraints for each segment. A long-range mission may be rejected if any required segment lacks authorization. Alternatively, the system may transform the mission into a series of legs, each requiring new authorization, custody transfer, vehicle transport, human escort, updated insurance, or an alternate route.

In some embodiments, municipal authorization comprises a machine-readable city operating credential analogous to a taxi medallion, vehicle registration, commercial vehicle permit, sidewalk robot operating permit, autonomous delivery permit, public-space fleet license, municipal franchise right, curb-access permit, airport operating credential, campus operating credential, premises operating credential, or other governmental or quasi-governmental operating authorization. The municipal authorization may be bound to a robot identity, fleet identity, responsible party account, route segment, operating zone, time window, passenger or payload class, speed envelope, insurance requirement, bond requirement, remote-supervision requirement, or public-space actuation envelope. The segment rule evaluator 430 may determine whether the mission authorization package 230 includes a valid municipal authorization for a corresponding jurisdiction-specific segment 410A, 410B, 410C, or 410D. The actuation control interface 132 may prevent mission initiation, prevent public-space operation, prevent entry into a jurisdiction-specific segment, reduce speed, disable manipulation, require custody transfer, require an alternate route, require vehicle transport, or transition the mobile physical AI agent to fallback custody when the municipal authorization is absent, expired, revoked, suspended, geographically inapplicable, restricted to a different mission class, or otherwise insufficient for the public-space mission.

For the San Francisco to New York example, the mission classifier 124 may identify the instruction as a long-range cross-jurisdiction public mission. The route segmentation module 420 may determine that the mission would cross numerous cities, counties, states, roads, sidewalks, trails, weather zones, charging networks, and private or restricted properties. The mission validation module 126 may determine that the owner has not provided jurisdiction-specific permissions, sufficient insurance, fallback custody points, energy or charging plans, or supervision coverage. The actuation control interface 132 may deny the mission, require a modified mission using authorized transport segments, require human escort, require vehicle boarding through an infrastructure gate, or issue only a limited authorization to move to a nearby staging or transport pickup location.

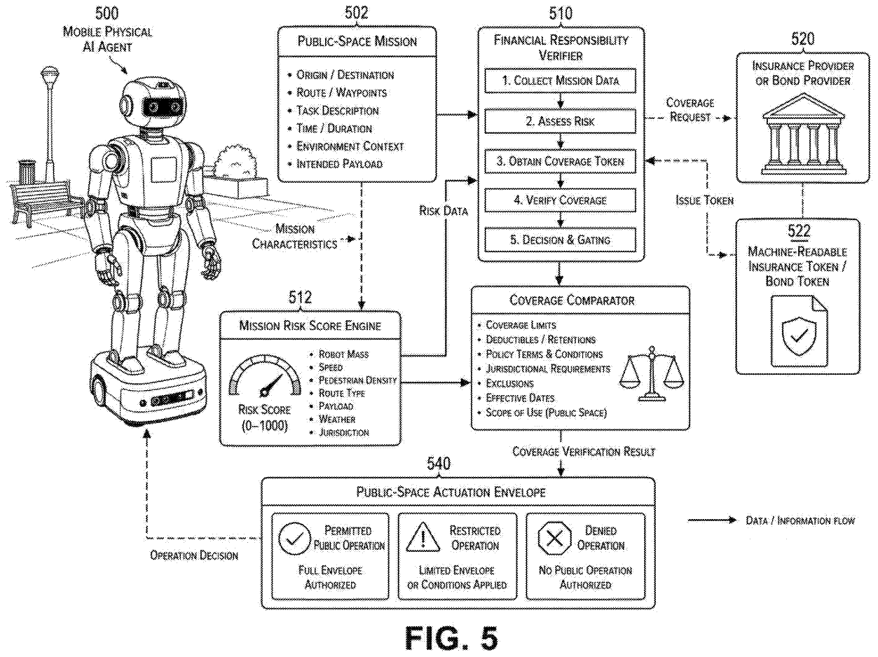

FIG. 5 illustrates insurance or bond-gated public operation. A mobile physical AI agent 500 is associated with a public space mission 502. A financial responsibility verifier 510 receives mission characteristics, mission risk data, and coverage information. The public space mission 502 may specify origin, destination, route, waypoints, task description, time, duration, environment context, and intended payload.

A mission risk score engine 512 may compute a mission risk score. The risk score may be based on robot mass, robot speed, energy capacity, manipulation capability, payload, expected pedestrian density, road crossings, weather, nighttime operation, historic incident data, sensor health, autonomy level, remote-supervision availability, owner reliability, maintenance state, jurisdictional complexity, and fallback-custody distance. The mission risk score may be expressed as a numeric value, class, tier, policy tag, or other machine-readable risk descriptor.

The financial responsibility verifier 510 may query an insurance provider or bond provider 520 for a machine-readable insurance or bond token 522. The token 522 may include a coverage amount, policy identifier, covered robot class, covered route, covered jurisdiction, covered time interval, covered payload, exclusions, deductible, incident reporting endpoint, emergency retrieval provider, and revocation status. The token 522 may be cryptographically signed and bound to the mobile physical AI agent 500, a responsible party account, a mission identifier, a time window, a payload, an operating environment, a route segment, a jurisdiction, or combinations thereof.

A coverage comparator 530 compares coverage represented by the token 522 with mission requirements and risk-score requirements. Coverage comparison may include coverage limits, deductibles, retentions, policy terms, conditions, jurisdictional requirements, exclusions, effective dates, scope of use, and whether public space operation is covered. If coverage is sufficient, a public space actuation envelope 540 may authorize permitted public operation. If coverage is insufficient or partially compliant, the public space actuation envelope 540 may impose restricted operation. If coverage is invalid, expired, revoked, excluded, insufficient for a route segment, below a risk threshold, or otherwise noncompliant, the public space actuation envelope 540 may deny operation.

Restricted operation may include pausing, moving out of a walkway, reducing speed, disabling manipulation, returning to private property, avoiding public space, continuing only to a nearest fallback custodian, entering fallback custody, or accepting municipal custody. In one embodiment, a locomotion controller checks a current coverage token before accepting a motion command in public space. In another embodiment, a public space actuation envelope 540 is generated only while valid coverage is present.

### C. Liability Attribution Ledger and Custody Transfer

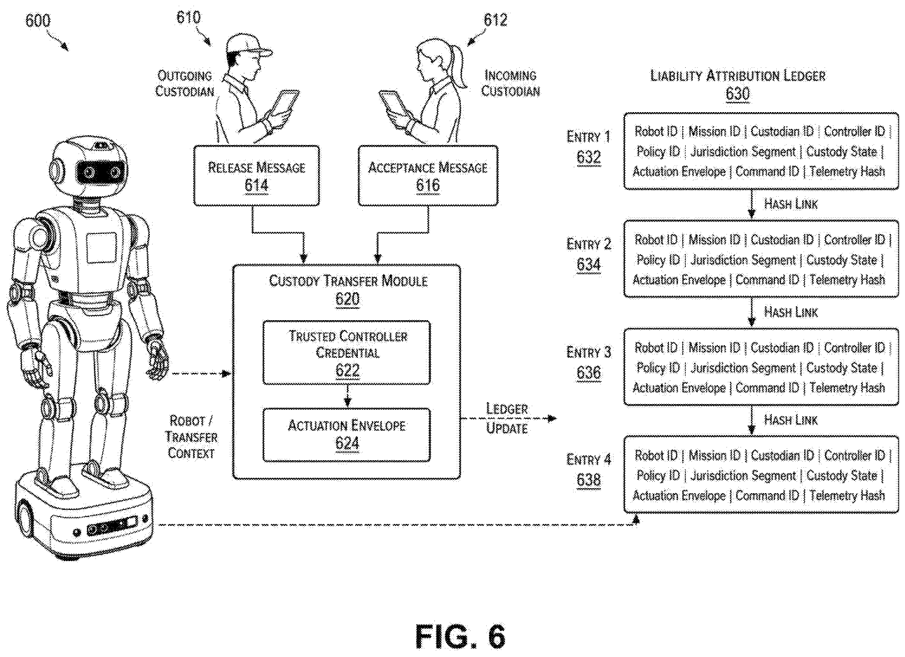

FIG. 6 illustrates a liability attribution ledger and custody transfer protocol. A mobile physical AI agent 600 may be associated with an outgoing custodian 610 and an incoming custodian 612. The outgoing custodian 610 may generate a release message 614 identifying the robot, mission, time window, permitted actions, custody scope, transfer conditions, and release signature. The incoming custodian 612 may generate an acceptance message 616 identifying accepted obligations, insurance coverage, service capability, permitted zones, time window, role, and acceptance signature.

A custody transfer module 620 receives the release message 614 and the acceptance message 616. The custody transfer module 620 may verify signatures, authority, insurance, permits, scope, time window, obligations, service capability, physical possession capability, infrastructure access, and whether the incoming custodian 612 can accept the robot under applicable rules. The custody transfer module 620 may update a trusted controller credential 622 and an actuation envelope 624 for the mobile physical AI agent 600.

The actuation envelope 624 may change based on the role of the incoming custodian 612. For example, a municipal custodian may be permitted to move the robot in an impound area while owner commands are locked out. A service depot may be permitted to manipulate the robot body, move the robot on a maintenance platform, open compartments, or disable power. A valet custodian may be permitted to guide the robot through a building but not access private owner data. A temporary steward may be authorized to supervise only a specific route segment or time window. When temporary stewardship expires, the robot may revert to owner custody, request renewal, enter fallback custody, or enter ghost state.

A liability attribution ledger 630 records responsibility-related events and robot action context. The ledger 630 may include ledger entries 632, 634, 636, and 638 linked by hash links or other tamper-evident relationships. Ledger entries may include robot ID, mission ID, custodian ID, controller ID, policy ID, jurisdiction segment, custody state, actuation envelope, command ID, telemetry hash, timestamp, location, owner identifier, responsible party identifier, planner identity, remote operator identity, insurance token hash, bond token hash, mission authorization package hash, sensor health, network state, supervision heartbeat state, custody transfer event, municipal override, safety override, ghost detection event, fallback custody event, impound event, physical action, or combinations thereof.

The ledger 630 may be implemented as a local append-only log, tamper-resistant black box, secure element log, cloud ledger, enterprise database, distributed ledger, blockchain, hash chain, signed event stream, or combinations thereof. The ledger need not publicly expose private data. In some embodiments, sensitive identities are stored as hashes, encrypted references, decentralized identifiers, escrowed credentials, or references resolvable only by authorized parties. A later dispute may be resolved by verifying signed custody-transfer entries and determining who had custody, what mission authorization package was active, what insurance token was valid, what jurisdiction segment applied, whether the robot was in ghost state, and what controller caused or permitted a physical action.

### D. Computing Environment

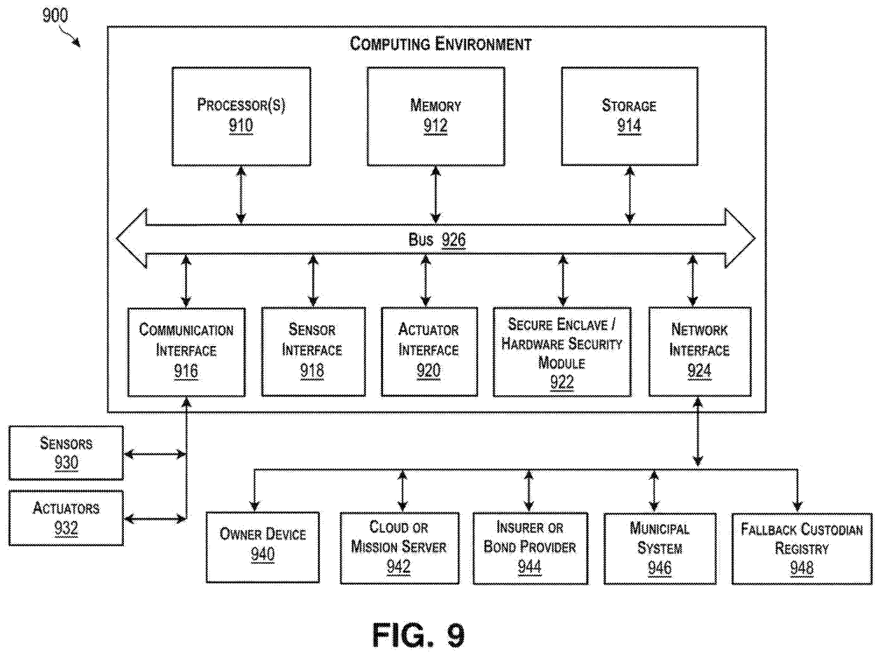

FIG. 9 illustrates a computing environment 900 for implementing one or more embodiments described herein. The computing environment 900 may be included within a mobile physical AI agent, owner device, fleet server, mission server, insurer system, bond-provider system, municipal system, fallback custodian registry, service depot system, cloud custody service, or distributed combination thereof.

The computing environment 900 may include one or more processors 910, memory 912, storage 914, communication interface 916, sensor interface 918, actuator interface 920, secure enclave or hardware security module 922, network interface 924, and bus 926. The processors 910 may include CPUs, GPUs, NPUs, tensor accelerators, microcontrollers, motor-control processors, safety processors, or other processing devices. The memory 912 and storage 914 may store instructions, mission authorization packages, mission authorization tokens, custody states, rule sets, jurisdictional policies, insurance or bond tokens, fallback custody data, ledger entries, route segments, risk-score data, and telemetry hashes.

The communication interface 916 may communicate with sensors 930, actuators 932, an owner device 940, a cloud or mission server 942, an insurer or bond provider 944, a municipal system 946, and a fallback custodian registry 948. Communications may use cellular, Wi-Fi, Bluetooth, ultra-wideband, satellite, vehicle-to-everything, mesh networking, near-field communication, wired connections, optical communication, or other communication technologies. Communications may be encrypted, signed, authenticated, or otherwise secured.

The sensor interface 918 may receive sensor data from sensors 930, including cameras, lidar, radar, ultrasound, inertial sensors, force sensors, tactile sensors, microphones, GPS, RTK-GPS, wheel encoders, joint encoders, battery sensors, current sensors, environmental sensors, network sensors, and other perception or state sensors. The actuator interface 920 may provide commands, releases, restrictions, derating signals, or envelopes to actuators 932, including locomotion actuators, manipulation actuators, motor drivers, power controllers, brakes, locking mechanisms, display devices, speakers, beacons, or other physical components.

The secure enclave or hardware security module 922 may store or verify cryptographic keys, responsible party credentials, robot identity, mission authorization tokens, custody transfer signatures, ledger signatures, certificate chains, municipal credentials, insurer credentials, fallback custodian credentials, or other trust materials. In some embodiments, a local secure element maintains a minimal set of mission authorization, custody, and fallback rules so that the robot can enter safe behavior when disconnected from the network.

The network interface 924 may communicate with the owner device 940, cloud or mission server 942, insurer or bond provider 944, municipal system 946, and fallback custodian registry 948. In one embodiment, the cloud or mission server 942 maintains regulatory rules, insurance tokens, fallback custodian registries, route segment policies, and mission authorization services, while the mobile physical AI agent locally enforces actuation restrictions. The system may be configured so that loss of cloud connectivity does not automatically create unsafe freedom of movement. Instead, the robot may continue only within a locally cached authorization envelope or transition to a reduced-risk state.

The computing environment 900 may support machine learning models for task classification, environment classification, risk scoring, route segmentation, abandonment detection, anomaly detection, or policy selection. However, the invention does not require any particular model type. Rule-based logic, lookup tables, deterministic policies, probabilistic models, neural networks, transformers, classifiers, graph algorithms, cryptographic protocols, or hybrid systems may be used.

### II. Methods for Ownership-Gated Mission Control

### A. Method for Ownership-Gated Mission Authorization

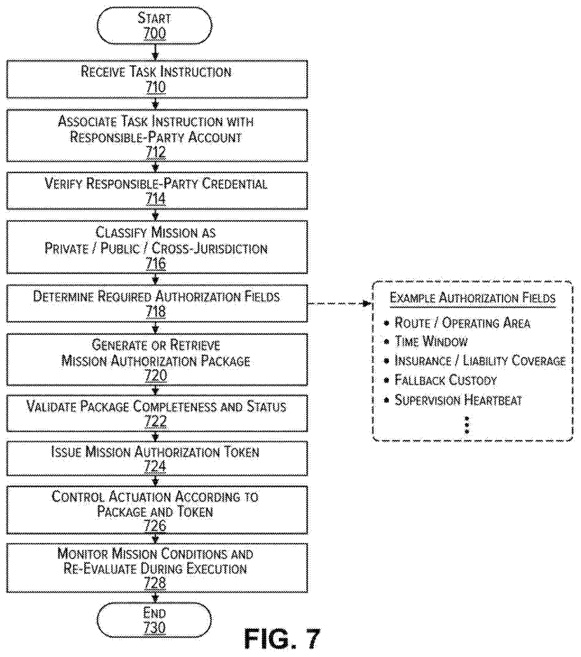

FIG. 7 illustrates a method 700 for ownership-gated mission authorization. The method begins at step 700 and includes receiving a task instruction at step 710. The task instruction may be received by a mobile physical AI agent, associated mission server, owner device, user account, fleet system, remote operator, AI planner, schedule, API, business system, or other command source. The task instruction may define a destination, route, object interaction, person-following behavior, errand, delivery, pickup, charging operation, service operation, vehicle boarding, infrastructure use, or other mission.

At step 712, the task instruction is associated with a responsible party account. The responsible party account may be an owner, custodian, fleet operator, employer, business, temporary steward, municipal agency, insurer-designated retrieval service, or other responsible entity. At step 714, a responsible party credential is verified. Verification may include determining whether the account currently has custody or authority over the robot and whether the account is permitted to request the mission class.

At step 716, the mission is classified as private, public, cross-jurisdiction, semi-public, long-range, high-risk, unattended, infrastructure-dependent, restricted-object, or otherwise subject to ownership-gated authorization. The robot or server may generate a candidate route, task graph, duration estimate, jurisdiction list, environment classification, risk estimate, or resource requirement.

At step 718, required authorization fields are determined. Required fields may include route or operating area, time window, insurance or liability coverage, fallback custody, supervision heartbeat, responsible party identity, owner command receipt, robot identity, route segment list, geofence, emergency contact, retrieval plan, jurisdictional permission, service account validity, maintenance state, municipal endpoint, or combinations thereof.

At step 720, a mission authorization package is generated or retrieved. The package may be completed by obtaining signatures, tokens, route data, policy data, insurance data, custodian acceptance, municipal rules, fallback custody commitments, or other fields. At step 722, package completeness and status are validated. Validation may include verifying that the package is complete, current, not revoked, bound to the robot, bound to the mission, bound to a time window, and sufficient for route segments or mission conditions.

At step 724, a mission authorization token is issued. The token may be stored locally by the robot, provided to a locomotion controller, provided to an actuator gate, stored in a ledger, or associated with the mission. The token may define a mission envelope including permitted locations, times, speeds, manipulation classes, supervision requirements, custody conditions, and revocation conditions.

At step 726, actuation is controlled according to the mission authorization package and token. Controlling actuation may include permitting, restricting, derating, or preventing locomotion or manipulation. At step 728, mission conditions are monitored and re-evaluated during execution. Re-evaluation may occur at time intervals, at route segment boundaries, at jurisdiction boundaries, upon loss of communication, upon insurance-token expiration, upon custody transfer, upon municipal instruction, upon sensor-health degradation, upon abnormal stagnation, or upon detection of an abnormal condition. The method ends at step 730, although one or more steps may be repeated during mission execution.

### B. Method for Ghost Robot Detection and Fallback Custody

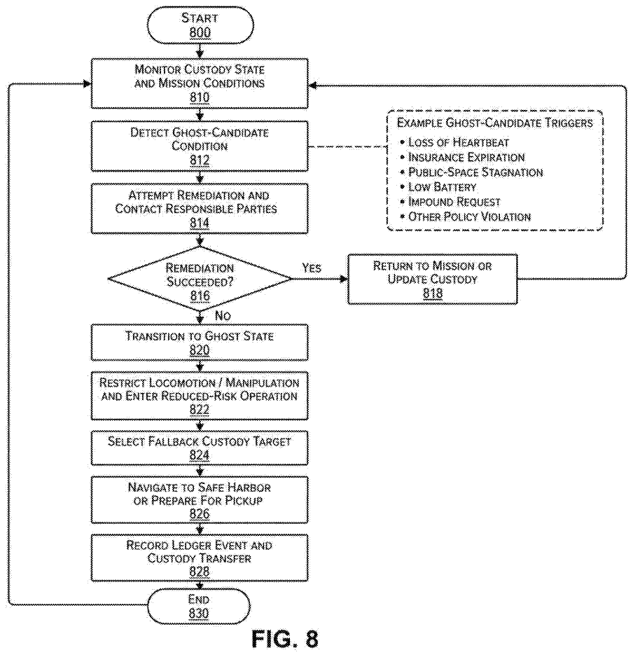

FIG. 8 illustrates a method 800 for ghost robot detection and fallback custody. The method begins at step 800 and includes monitoring custody state and mission conditions at step 810. Monitoring may include tracking owner heartbeat, custodian heartbeat, mission time, route progress, location, environment classification, insurance status, bond status, service account status, energy state, physical health, network state, municipal messages, sensor status, and public space dwell time.

At step 812, a ghost candidate condition is detected. Example ghost candidate triggers may include loss of heartbeat, insurance expiration, public space stagnation, low battery, impound request, policy violation, failure to receive owner or custodian acknowledgements, mission expiration, failure to make route progress, stranded state, damaged state, tip-over state, blocked state, or absence of a valid accountable custodian.

At step 814, remediation is attempted and responsible parties are contacted. Remediation may include contacting the owner, contacting alternate contacts, contacting the custodian, contacting a fleet operator, contacting an insurer, contacting a retrieval service, requesting renewed insurance, requesting mission extension, requesting custody transfer, querying a fallback custodian registry, or contacting a municipal endpoint.

At decision step 816, the system determines whether remediation succeeded. If remediation succeeds, the system returns to the mission or updates custody at step 818. Updating custody may include extending the mission authorization package, issuing a renewed mission authorization token, transferring custody, updating a supervision heartbeat, updating an insurance or bond token, or modifying an actuation envelope. The system may then return to monitoring at step 810.

If remediation does not succeed, the system transitions to a ghost state at step 820. At step 822, the system restricts locomotion or manipulation and enters reduced-risk operation. Reduced-risk operation may include disabling manipulation, disabling payload release, disabling high-speed locomotion, disabling road crossing, disabling stair traversal, disabling door manipulation, disabling following behavior, reducing speed, moving out of pedestrian flow, displaying an emergency contact, broadcasting a beacon, preserving logs, or operating only toward fallback custody.

At step 824, a fallback custody target is selected. The fallback custody target may be a service depot, charging station, robot shelter, municipal impound location, owner property, public safe harbor, retrieval pickup point, insurer-designated retrieval location, emergency staging area, or other safe custody endpoint. Selection may be based on distance, route safety, remaining energy, robot class, operating hours, jurisdiction, acceptance capability, contractual relationship, and physical accommodation capability.

At step 826, the robot navigates to a safe harbor or prepares for pickup. If navigation is unsafe or unauthorized, the robot may self-immobilize, move to a low-obstruction zone, wait for pickup, display status, or accept municipal custody. At step 828, a ledger event and custody transfer are recorded. The recorded event may include ghost-state transition, fallback custody target, responsible party contact attempts, active token status, actuation envelope, location, timestamp, and custody acceptance. The method ends at step 830, although monitoring may continue in a reduced-risk or fallback custody state.

### III. Generalities

The terms “mobile physical AI agent,” “robot,” and “physical AI agent” are used broadly to refer to any machine capable of physical movement in an environment under at least partial control of software, firmware, artificial intelligence, remote commands, or autonomous planning. Examples include humanoid robots, wheeled robots, quadruped robots, mobile manipulators, delivery robots, autonomous errand robots, telepresence robots, service robots, drones configured for ground or mixed operation, industrial mobile robots, sidewalk robots, consumer robots, and robot passengers in autonomous vehicles.

The term “public space mission” includes missions performed at least partly in public, semi-public, shared, municipal, commercial, or third-party environments. A mission need not occur entirely in public to be a public space mission. For example, a mission that begins in a home, traverses a sidewalk, enters a store, uses an elevator, boards a vehicle, or travels through a campus may be a public space or semi-public space mission.

The term “responsible party” refers to an entity or account that is accountable for some aspect of robot operation. A responsible party may be an owner, user, lessee, operator, fleet manager, parent account, employer, custodian, temporary steward, business, municipal agency, insurer-designated retrieval service, premises operator, or other entity.

The term “custody” refers to operational responsibility, authority, or stewardship over a robot, and does not require physical possession. A robot may be in custody of an owner while in a home, in custody of a fleet operator during a delivery, in temporary custody of a service depot during repair, in municipal custody during impound, or in fallback custody while being recovered after abandonment.

The term “mission authorization package” refers to any data structure, collection of credentials, token, signed manifest, rule set, policy graph, certificate, or other machine-readable information used to determine whether a robot may perform a mission. A mission authorization package may be stored locally, remotely, or distributed among multiple systems. It may be generated before mission initiation or updated during mission execution.

The term “mission authorization token” refers to any machine-readable authorization artifact, including a cryptographic token, signed certificate, policy grant, actuation release token, route-segment token, custody token, insurance-backed token, or other authorization object used by a robot, controller, operating system, actuator firewall, motor driver, or mission server to determine whether physical operation is permitted under a current mission envelope.

The term “ghost robot” refers to a robot that lacks valid mission authorization, lacks a reachable responsible party, lacks valid custody, lacks valid financial responsibility, is abandoned, is orphaned, is in an expired mission state, or is otherwise no longer under acceptable responsible party control while occupying or attempting to occupy a public or semi-public environment. The term is descriptive and does not require a legal determination of abandonment.

The term “fallback custody” refers to a state, plan, location, entity, or process for transferring or limiting robot operation when ordinary mission custody fails, expires, is revoked, or becomes unavailable. Fallback custody may include moving to a service center, municipal impound location, charging station, robot shelter, owner property, retrieval pickup point, or other safe custody endpoint.

The term “insurance token” or “bond token” refers to machine-readable information indicating financial responsibility, coverage, surety, escrow, payment, or other backing associated with robot operation. The token may be cryptographic or non-cryptographic, local or remote, mission-specific or account-specific, and may include limitations, exclusions, time windows, routes, jurisdictions, or robot classes.

The disclosed embodiments may be combined in any suitable manner. For example, ownership-gated mission authorization may be combined with ghost robot detection, insurance-gated operation, cross-jurisdiction segmentation, custody transfer, and a liability ledger. Any module described as local may be remote, and any module described as remote may be local, provided that the robot has an enforcement mechanism for restricting physical operation when required conditions are not satisfied.

The ordering of method steps may be varied unless a particular order is expressly required. Certain steps may be omitted, repeated, performed in parallel, or performed by different components. For example, insurance verification may occur before route segmentation, after route segmentation, periodically during execution, or upon entry into a new jurisdiction. Custody transfer may occur before mission initiation, during a mission, at a jurisdiction boundary, at a service depot, at an impound location, or upon fallback custody.

The disclosed systems may be implemented using hardware, software, firmware, or combinations thereof. Components may be distributed across a robot, owner device, fleet server, cloud service, insurer service, municipal service, infrastructure system, service depot, fallback custodian registry, or other computing environment. Communication among components may be direct, indirect, synchronous, asynchronous, intermittent, or store-and-forward.

Although examples refer to a robot walking from San Francisco to New York, the disclosed techniques apply to any mission in which a mobile physical AI agent may leave private custody, operate in shared space, cross jurisdictional or premises boundaries, require financial responsibility, or require fallback custody. The example is illustrative and not limiting.

### ADDITIONAL EMBODIMENTS

[symbol]

I claim:

1. A mobile physical AI agent comprising:
a locomotion system configured to move the mobile physical AI agent through an environment;
one or more processors;
an ownership authorization module configured to associate a received task instruction with a responsible party account;
a mission validation module configured to determine that the received task instruction corresponds to a public space mission and to generate a mission authorization package defining at least a permitted mission scope and a fallback custody condition;
a token generator configured to generate a mission authorization token bound to a robot identity and the mission authorization package; and
an actuation control interface configured to permit, restrict, or prevent operation of the locomotion system based on whether a current state of the mobile physical AI agent satisfies the mission authorization package and whether the mission authorization token is valid for a current actuation envelope.

2. The mobile physical AI agent of claim 1, wherein the mission authorization package further includes at least one of a robot identity, an owner identity, a custodian identity, a route condition, a geofence condition, a jurisdictional condition, a mission duration condition, a supervision heartbeat condition, an insurance token, a bond token, a service account condition, an emergency contact, or a municipal endpoint.

3. The mobile physical AI agent of claim 1, wherein the mission validation module is configured to classify the received task instruction as the public space mission based on at least one of a travel distance, a travel duration, an unattended-operation duration, a number of jurisdictional boundaries, a route class, a public space exposure, or an object-manipulation requirement.

4. The mobile physical AI agent of claim 1, wherein the received task instruction comprises a natural-language instruction to travel between a first city and a second city, and wherein the mission validation module determines that the natural-language instruction requires cross-jurisdiction mission authorization before the locomotion system is permitted to execute the natural-language instruction.

5. The mobile physical AI agent of claim 1, further comprising a custody state machine configured to maintain a custody state selected from at least an active mission state, an owner-unreachable state, a mission-expired state, a fallback custody state, a ghost robot state, or a municipal impound state.

6. The mobile physical AI agent of claim 5, wherein the custody state machine transitions to the ghost robot state based on at least one of loss of communication with the responsible party account, expiration of a mission duration condition, invalidation of an insurance token, invalidation of a bond token, failure to make route progress, or a municipal impound instruction.

7. The mobile physical AI agent of claim 6, wherein, in the ghost robot state, the actuation control interface disables object manipulation while permitting restricted locomotion toward a fallback custody location.

8. The mobile physical AI agent of claim 1, further comprising a jurisdiction segmentation module configured to partition a route of the public space mission into a plurality of jurisdiction-specific segments and to associate respective operating constraints with the plurality of jurisdiction-specific segments.

9. The mobile physical AI agent of claim 8, wherein the actuation control interface prevents the mobile physical AI agent from entering a jurisdiction-specific segment for which the mission authorization package lacks a required authorization condition.

10. The mobile physical AI agent of claim 1, further comprising a financial responsibility verifier configured to verify a machine-readable insurance token or bond token associated with the public space mission, wherein the actuation control interface restricts public space locomotion when the machine-readable insurance token or bond token is invalid.

11. The mobile physical AI agent of claim 10, wherein the financial responsibility verifier determines whether coverage represented by the machine-readable insurance token or bond token satisfies a mission risk score determined based on at least one of robot mass, robot speed, route type, pedestrian density, payload, operating time, weather, or jurisdiction.

12. The mobile physical AI agent of claim 1, further comprising a liability attribution ledger configured to record time-stamped entries identifying at least one of a robot identifier, mission identifier, custodian identifier, controller identifier, policy identifier, jurisdiction segment, custody state, actuation envelope, command identifier, or telemetry hash.

13. The mobile physical AI agent of claim 12, wherein the liability attribution ledger cryptographically links successive entries to provide a tamper-evident record of custody and control associated with physical actions of the mobile physical AI agent.

14. The mobile physical AI agent of claim 1, further comprising a custody transfer module configured to verify a release message from an outgoing custodian and an acceptance message from an incoming custodian before changing a trusted controller credential for the mobile physical AI agent.

15. The mobile physical AI agent of claim 14, wherein the custody transfer module changes an actuation envelope of the mobile physical AI agent based on a role of the incoming custodian.

16. A method comprising:
receiving, by a mobile physical AI agent, a task instruction associated with a responsible party account;
classifying the task instruction as a public space mission requiring ownership-gated authorization;
generating a mission authorization package defining a permitted mission scope, a mission duration condition, and a fallback custody condition;
determining, during execution of the public space mission, whether a current state of the mobile physical AI agent satisfies the mission authorization package; and
restricting locomotion or manipulation by the mobile physical AI agent in response to determining that the current state does not satisfy the mission authorization package.

17. The method of claim 16, further comprising generating a mission authorization token bound to a robot identity, a mission identifier, and a time window, and permitting a locomotion controller to execute motion commands only while the mission authorization token is valid.

18. The method of claim 16, further comprising detecting a ghost robot condition based on loss of communication with the responsible party account and expiration of the mission duration condition, and navigating the mobile physical AI agent toward a fallback custody location under a restricted actuation envelope.

19. The method of claim 16, further comprising segmenting a route of the public space mission into jurisdiction-specific segments and applying different locomotion constraints to the mobile physical AI agent in different ones of the jurisdiction-specific segments.

20. A non-transitory computer-readable medium storing instructions that, when executed by one or more processors of a mobile physical AI agent, cause the mobile physical AI agent to:
verify a responsible party credential associated with a task instruction;
determine whether the task instruction requires public space mission authorization;
generate a mission authorization package including at least one of a route condition, a duration condition, a jurisdictional condition, a financial responsibility condition, or a fallback custody condition; and
control an actuation interface of the mobile physical AI agent according to the mission authorization package.
